(19) United States
(12) Patent Application Publication
(10) Pub. No.: US 2022/0345520 A1
(43) Pub. Date: Oct. 27, 2022

(54) Method for Operating a Forest Communication System and to a Forest Communication System

(71) Applicant: Andreas Stihl AG & Co. KG, Waiblingen (DE)

(72) Inventors: Nils CONRAD, Korb (DE); Julian DANNER, Grosserlach (DE); Harald MANG, Winnenden (DE)

(21) Appl. No.: 17/726,816

(22) Filed: Apr. 22, 2022

(30) Foreign Application Priority Data
Apr. 23, 2021 (EP) 21170174.3

(51) Int. Cl. H04L 67/104; H04L 67/12; G06Q 10/06; G06Q 50/02

(52) U.S. Cl. CPC H04L 67/104; H04L 67/12; G06Q 10/063114; G06Q 50/02

(57) ABSTRACT

A method operates a forest communication system having multiple mobile communication apparatus, the communication apparatus each including an output and input device. The output and input device is designed for the output and input of work process data relevant to one member in a working group about work steps on tree sections that are to be worked on and/or have been worked on. The method reconciles the work process data between the communication apparatus in a peer-to-peer network by way of wireless transmission on the basis of a medium-range transmission technology.

### CROSS REFERENCE TO RELATED APPLICATION

This application claims priority under 35 U.S.C. § 119 from European Patent Application No. 21170174.3, filed Apr. 23, 2021, the entire disclosure of which is herein expressly incorporated by reference.

### BACKGROUND AND SUMMARY OF THE INVENTION

The invention relates to a method for operating a forest communication system and to a forest communication system.

The invention is based on the object of providing a method for operating a forest communication system and a forest communication system, each of which has improved properties, in particular allows efficient and/or reduced-danger working in the forest.

The invention achieves the object by providing a method and a forest communication system having the features of the independent claims. Advantageous developments and/or configurations of the invention are described in the dependent claims.

The, in particular automatic, method according to the invention is designed, or configured, or provided, for, in particular automatically, operating an, in particular electrical, forest communication system. The forest communication system includes, or comprises, multiple mobile, in particular electrical, communication apparatus. The communication apparatus each include, or comprise, an, in particular electrical, output and input device. The output and input device is designed, or configured, for the, in particular automatic, output and for the, in particular automatic, input of work process data, in particular values and/or content of the work process data, relevant to, in particular at least, one member, or one participant, in a working group about work steps on tree sections, in particular trees, that are to be worked on and/or have been worked on. The method includes, or comprises, the step of: reconciling, in particular automatically and/or multilaterally, or bidirectionally, reconciling and/or matching and/or synchronizing, the work process data between the communication apparatus in a peer-to-peer network, in particular at least, by means of wireless, or cable-free, transmission, in particular automatic transmission, on the basis of a, in particular at most, medium-range, in particular digital, transmission technology, in particular radio transmission technology.

This allows, in particular the peer-to-peer network and the medium-range transmission technology allow, a reliability of the transmission and hence of the reconciling of the work process data between the communication apparatus, in particular in the forest, or wood, and/or offline, that is to say without mobile radio connection, or reception. Additionally or alternatively, this, in particular the reconciling of the work process data between the communication apparatus, allows, in particular dynamic, or updated, coordination, or harmonization, of the work steps and/or, in particular therefore, efficient and/or reduced-danger working by the working group, in particular in the forest.

In particular, transmission of work process data in the forest may be difficult, in particular unreliable, in the case of a method not according to the invention. This is because in the forest there may be no infrastructure for transmission, in particular in contrast to the city.

The peer-to-peer network may be autonomous, or independent.

The reconciling of the work process data between the communication apparatus does not need to or may not be and/or be performed in a client-server network and/or by means of wireless transmission on the basis of a long-range transmission technology.

The peer-to-peer network may be defined by the communication apparatus and/or the working group.

The working group may be defined by the work steps and/or the tree sections and/or their members.

The work steps may be interrelated, or interdependent, or interharmonizable, or, in particular chronologically, successive, work steps. Additionally or alternatively, the work steps may need to be performed, or may be performed and/or may have been performed, by the working group, or the tree sections may need to be worked on, or may be worked on and/or may have been worked on, by the working group.

The member may be a user, or a natural person, or a human being, in particular a forestry worker, or a machine.

The output and input device may be a user output and input device. Additionally or alternatively, the output and input device may be designed for output of the work process data, in particular about at least one work step on at least one tree section that is to be worked on, to the member and/or for input of the work process data, in particular about at least one work step on at least one tree section that has been worked on, by the member. Further additionally or alternatively, the output and input device may have a display, a vibration device and/or a sound generator, in particular a loudspeaker, for output of the work process data and/or for visual, haptic and/or audible output of the work process data. Further additionally or alternatively, the output and input device may have a keypad, in particular a touch display, and/or a voice input device, in particular a microphone, for input of the work process data and/or for touch-influenced, or touch-sensitive, or haptic, and/or audible input of the work process data.

The method may comprise the step of: outputting, in particular visually, haptically and/or audibly outputting, the, in particular non-aligned or aligned, work process data, in particular by means of the output and input device. Additionally or alternatively, the method may comprise the step of: entering, in particular recording an input of, the work process data, in particular by means of the output and input device.

The reconciling of the work process data may be and/or be performed on the communication apparatus.

The method may be repeated, in particular multiple times, in particular for each work step.

The communication device may comprise, in particular be, a terminal and/or a smartphone. Additionally or alternatively, the communication device may be present, in particular already. Further additionally or alternatively, the communication device may comprise at least one transmission device for, in particular for the, transmission, in particular of the work process data.

The work process data may be predefined, in particular at the beginning and/or at least in part, in particular by a forestry system.

The tree sections may be in the forest. Additionally or alternatively, the tree sections may comprise, in particular be, a tree trunk and/or a trunk section. Further additionally or alternatively, the tree sections may, in particular each, be standing, in particular living, felled and/or lying.

In one development of the invention, the work process data are about at least one planting step, at least one young stock maintenance step, at least one cutting-back step, at least one pruning step, at least one felling step, at least one limbing step, at least one cutting-to-length step, at least one log-removal step, at least one leaning-tree clearance step, at least one, in particular chronological, sequence and/or at least one, in particular respective, location of at least some, in particular all, of the work steps and/or of at least some, in particular all, of the tree sections, at least one tree type, at least one tree section length, at least one tree section diameter, at least one tree section quantity, at least one tree section quality and/or at least one tree section value. Reconciling such work process data, in particular such work steps and/or such properties, allows particularly advantageous working by the working group. In particular, the properties, in particular at least in part, may be measured, in particular by the member and/or the working group. Additionally or alternatively, the location may have been and/or be determined, in particular recorded, in particular automatically, in particular by means of the communication device and/or a location determination device, in particular of the communication device, in particular as a result of the input. In particular, the location determination device may comprise, in particular be, a satellite position determination receiver.

In one development of the invention, on the basis of triggering by any, in particular new, input of, in particular new, work process data, in particular by means of one of the output and input devices, the respective reconciling is performed, in particular afresh, or again, and/or immediately, or in real time, and/or automatically. This allows the work process data to be up to date, or consistent. In particular, the input, in particular by the member, may be and/or be performed as a result of performance of at least one work step, or at least one work operation, on at least one tree section, in particular by the member.

In particular, the input may comprise, in particular be, confirmation of the output work process data and/or work process data that differ from the output work process data.

In one development of the invention, the reconciling includes, or comprises: comparing, in particular automatically comparing, work process data that have been input, in particular by means of one of the output and input devices, with predefined work process data that have been output, in particular by means of the output and input device. When there is a minimum variance, in particular between the predefined work process data and the input work process data, adapting, in particular automatically adapting and/or changing and/or modifying, the predefined work process data about work steps on tree sections that are to be worked on on the basis of the minimum variance and/or the input work process data, in particular on the basis of an, in particular at least one, optimization or adaptation criterion. This allows reorganization of the work steps, in particular that are to be performed, when there is the minimum variance, in particular if the work process data, or at least one work step, or at least one work operation, on at least one tree section, cannot and/or has not been able to be performed, or worked on, as predefined. Additionally or alternatively, the minimum variance allows the adapting when there is a relevant variance, in particular outside a tolerance, and/or allows the adapting to be avoided when there is a non-relevant variance, in particular within a tolerance. In particular, adapting does not need to or may not be performed when there is no minimum variance. Additionally or alternatively, the optimization criterion may be predefined.

In one configuration of the invention, the optimization criterion is a danger reduction optimization criterion, a, in particular spatial, distance optimization criterion and/or a, in particular fastest, overall, or group, work progress optimization criterion, a time optimization criterion and/or a value optimization criterion. Such an optimization criterion allows relationships between the work steps, or dependencies among the work steps, or a, in particular chronological, succession of the work steps, to be taken into consideration. In particular, the danger reduction optimization criterion allows possible dangers to be reduced. Additionally or alternatively, the distance optimization criterion allows the members of the working group to be prevented from working too close and hence in a manner that possibly adversely affects, or blocks, one another and/or from working too remotely and hence in a manner in which they are unable to help one another. In particular, the danger reduction optimization criterion and/or the distance optimization criterion may be characteristic of a, in particular spatial, minimum distance and/or a, in particular spatial, maximum distance between locations of at least some, in particular all, of the work steps and/or of at least some, in particular all, of the tree sections. Further additionally or alternatively, the group work progress optimization criterion and/or the time optimization criterion allow/allows work by one member of the working group to be prevented from being blocked by another member of the working group and/or allow/allows a solution, or assistance, in this event, in particular if the work process data, or at least one work step, or at least one work operation, on at least one tree section, cannot and/or has not been able to be performed, or worked on, by the member as predefined. Further additionally or alternatively, the value optimization criterion allows a value of the tree sections that are worked on, in particular then, to be increased. In particular, the value optimization criterion may be characteristic of different tree section values, in particular tree section prices, for every tree type, for every tree section length, for every tree section diameter, for every tree section quantity and/or for every tree section quality.

In one configuration of the invention, the method includes, or comprises, the step of: responding to the minimum variance, and in particular responding to the adapting on the basis of the danger reduction optimization criterion, by outputting, in particular automatically outputting, information, in particular a value and/or a content of the information, about the minimum variance and/or the adapting and/or the adapted work process data and/or the optimization criterion, in particular by means of at least one of the output and input devices. This allows the, in particular danger-reduction-optimization-contingent, adapting to be perceived. In particular, the information may be perceptible to a user.

In one configuration of the invention, the method includes, or comprises, the step of: enabling, in particular automatically enabling, the adapted work process data for manual adapting, in particular by means of at least one of the output and input devices. In particular, the manual adapting may be and/or be performed by at least one of the users.

In one development of the invention, the method includes, or comprises, the step of: transmitting, in particular automatically transmitting, the, in particular predefined, work process data from an external, in particular electrical, database to a, in particular electrical, gateway, in particular a smartphone, in the peer-to-peer network, in particular wirelessly on the basis of a long-range, in particular digital, transmission technology, in particular radio transmission technology. This allows the work process data to get into the peer-to-peer network, or to the communication apparatus. In particular, the transmission wirelessly on the basis of the long-range transmission technology allows the work process data to be transmitted into the forest. In particular, the database may be a database of a forestry system. Additionally or alternatively, the database may be provided locally and/or by means of a distributed system, in particular in the form of a cloud. Further additionally or alternatively, the reconciling of the work process data between the communication apparatus does not need to or may not be and/or be performed by means of wireless transmission on the basis of the long-range transmission technology. This is because not every communication device in the forest may be online, that is to say with mobile radio connection, or reception. Additionally or alternatively, the long-range transmission technology may be different from the medium-range transmission technology, in particular may have a greater range and/or, in particular therefore, a higher energy requirement. Further additionally or alternatively, at least one of the communication apparatus may be and/or constitute the gateway. Further additionally or alternatively, the gateway may be mobile.

In one development of the invention, the forest communication system includes, or comprises, at least one mobile, in particular electrical, communication intermediate station. Additionally or alternatively, the reconciling is performed between at least one of the communication apparatus and a, in particular the and/or associated, communication intermediate station in the peer-to-peer network by means of wireless transmission, in particular automatic transmission, on the basis of a short-range, in particular digital, transmission technology, in particular radio transmission technology, and by the communication intermediate station by means of the wireless transmission on the basis of the medium-range transmission technology, in particular to at least one further communication intermediate station. This, in particular the wireless transmission on the basis of the short-range transmission technology between the communication device and the communication intermediate station, allows the reconciling between the communication apparatus by means of wireless transmission on the basis of the medium-range transmission technology and/or a synergistic effect. In particular, the communication device does not need to or may not, in particular itself, be designed for the wireless transmission on the basis of the medium-range transmission technology, or the communication intermediate station may be better than the communication device, in particular optimized, for the wireless transmission on the basis of the medium-range transmission technology. Additionally or alternatively, the communication intermediate station may be present, in particular already, in particular for a voice message from one of the members and/or between the communication intermediate stations. Further additionally or alternatively, the communication intermediate station may comprise an, in particular electrical, output and/or input device, in particular user output and/or input device. In particular, the output and input device may be designed as cited above. In other words: the output and/or input device may be designed for the, in particular visual, haptic and/or audible, output, in particular user output, and/or for the, haptic and/or audible, input, in particular user input, in particular of the work process data. Further additionally or alternatively, the communication intermediate station may comprise at least one transmission device for, in particular for the, transmission, in particular of the work process data. Further additionally or alternatively, the short-range transmission technology may be different from the medium-range transmission technology, in particular may have a shorter range and/or, in particular therefore, a lower energy requirement. Further additionally or alternatively, the location may have been and/or be determined by means of the communication intermediate station, in particular the location determination device of the communication intermediate station.

In particular, the communication device and/or the communication intermediate station may, in particular each, be incorporated, in particular permanently, in a vehicle, in particular an automobile.

In one development, in particular one configuration, of the invention, at least one of the communication apparatus is a body-worn, in particular head-worn, and/or handheld communication device. Additionally or alternatively, at least the communication intermediate station, where present, is a body-worn, in particular head-worn, and/or handheld communication intermediate station. In particular, the communication device and/or the communication intermediate station is/are, in particular in each case, at least arranged, in particular mounted, in particular integrated, on an item of forestry worker protective equipment, in particular a protective helmet and/or a face and/or hearing protector and/or protective goggles and/or a protective glove. This allows the communication device and/or the communication intermediate station to be easily carried. In particular, body-worn and/or handheld can mean that the communication device and/or the communication intermediate station may, in particular each, have a maximum mass of 10 kg (kilogrammes), in particular of 5 kg, in particular of 2 kg, in particular of 1 kg, in particular of 0.5 kg, in particular of 0.2 kg, in particular of 0.1 kg, in particular of 0.05 kg. Additionally or alternatively, the communication device, in particular the output and input device, and/or the communication intermediate station may comprise, in particular be, headphones, in particular a headset. Further additionally or alternatively, the display, where present, may be designed for display, in particular for projection, or insertion, into a field of vision of the user and/or onto a visor of the protective helmet, of the face and/or hearing protector and/or of the protective goggles, in particular in front of the tree section. In particular, the display can be referred to as a head-up display and/or head-mounted display in English. Additionally or alternatively, this can be referred to as virtual reality and/or as augmented reality in English.

In one development, in particular one configuration, of the invention, the method includes, or comprises, the step of: in particular at least, wirelessly transmitting, in particular automatically transmitting, a, in particular the, voice message, in particular a content of the voice message, in particular from one of the members and/or between the communication intermediate stations, where present, on the basis of the, in particular at most, medium-range transmission technology in the peer-to-peer network. This allows a synergistic effect. In particular, the voice message may have been and/or be recorded by means of the communication intermediate station.

In one development of the invention, the method includes, or comprises, the step of: wirelessly transmitting, in particular automatically transmitting, emergency data and/or messages, in particular values and/or content of the emergency data and/or messages, in particular from one of the members, on the basis of the medium-range transmission technology in the peer-to-peer network and/or on the basis of a, in particular the and/or digital, long-range transmission technology, in particular radio transmission technology. This allows a probability of reception of the emergency data and/or messages to be increased and/or, in particular therefore, a probability of receiving assistance in an emergency to be increased. In particular, the long-range transmission technology may be different from the medium-range transmission technology, in particular may have a greater range and/or, in particular therefore, a higher energy requirement. Additionally or alternatively, the emergency data and/or messages may have been and/or be input by means of the output and input device. Further additionally or alternatively, the emergency data and/or messages may be provided with emergency location information.

In one development, in particular one configuration, of the invention, the medium-range transmission technology has a maximum range of 400 m (metres). Additionally or alternatively, the medium-range transmission technology includes, or comprises, Bluetooth Classic transmission technology, in particular is Bluetooth Classic transmission technology. Further additionally or alternatively, the medium-range transmission technology uses a 2.4 GHz (gigahertz) carrier frequency. Further additionally or alternatively, the long-range transmission technology, where present, has a minimum range of 1000 m. Further additionally or alternatively, the long-range transmission technology, where present, includes, or comprises, narrowband Internet of Things transmission technology, Long-Term Evolution transmission technology, long-range transmission technology and/or SigFox transmission technology, in particular is narrowband Internet of Things transmission technology, Long-Term Evolution transmission technology, long-range transmission technology and/or SigFox transmission technology. Further additionally or alternatively, the short-range transmission technology, where present, has a maximum range of 10 m. Further additionally or alternatively, the short-range transmission technology includes, or comprises, Bluetooth Low Energy transmission technology and/or ZigBee transmission technology, in particular is Bluetooth Low Energy transmission technology and/or ZigBee transmission technology. In particular, the long-range transmission technology can have a maximum range of 10 000 m.

In particular, the communication apparatus and/or the communication intermediate station may, in particular each, be designed for transmission, in particular of the emergency data and/or messages, on the basis of the short-range transmission technology from and/or to at least one, in particular further, body-worn and/or handheld transmission apparatus. In particular, the transmission apparatus may comprise an, in particular electrical, output and/or input device, in particular user output and/or input device. Additionally or alternatively, the transmission apparatus may be arranged on, in particular integrated in, an implement, or processing device, for working on the tree sections. Further additionally or alternatively, the transmission apparatus may be designed for generation, and in particular for transmission, of data, the data possibly being intended to be taken into consideration in the work process, in particular when performing the work steps.

In one development of the invention, the communication apparatus, and in particular the communication intermediate station, each include, or comprise, a, in particular electrical and/or magnetic and/or optical, storage medium. The storage medium is designed, or configured, for storage, in particular automatic storage, of the work process data. This allows the work process data to be aligned between the communication apparatus in the peer-to-peer network. In particular, as a result of the reconciling, each of the storage media may comprise, or contain, identical, in particular the same, data, or the data may be replicated. Additionally or alternatively, the method may comprise the step of: storing, in particular automatically storing, the, in particular aligned and/or transmitted, work process data, in particular by means of the storage medium.

The forest communication system according to the invention comprises multiple mobile, in particular the multiple mobile, communication apparatus. The communication apparatus each have an, in particular the, output and input device. The output and input device is designed for the output and input of, in particular the, work process data relevant to one, in particular the, member in a, in particular the, working group about, in particular the, work steps on tree sections that are to be worked on and/or have been worked on, in particular the tree sections that are to be worked on and/or have been worked on. The forest communication system is designed for, in particular for the, reconciling of the work process data between the communication apparatus in a, in particular the, peer-to-peer network by means of wireless transmission on the basis of a, in particular the, medium-range transmission technology.

The forest communication system may allow at least some or all of the advantages as cited above for the method.

In particular, the forest communication system, in particular the communication apparatus and/or the communication intermediate station, in particular a processor of the forest communication system and/or of at least one of the communication apparatus and/or of the communication intermediate station, may be designed, or configured, for performing the method cited above. Additionally or alternatively, the forest communication system may, at least in part or completely, be designed, or configured, as cited above for the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of a forest communication system according to an embodiment of the invention and an exemplary method for operating the forest communication system.

FIG. 2 is a schematic view of a communication device and a communication intermediate station of the forest communication system in FIG. 1.

### DETAILED DESCRIPTION OF THE DRAWINGS

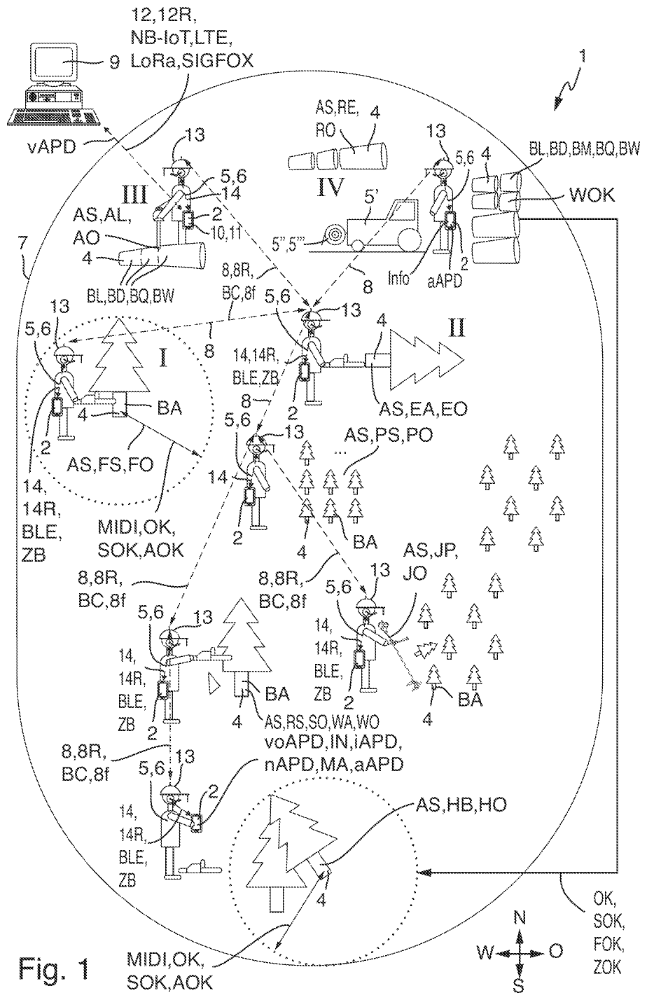

FIG. 1 shows a forest communication system 1 and a method for operating the forest communication system 1.

The forest communication system 1 comprises multiple mobile communication apparatus 2. In the exemplary embodiment shown, the forest communication system 1 comprises eight communication apparatus 2. In alternative exemplary embodiments, the forest communication system may comprise at least two, in particular at least five, in particular at least ten, communication apparatus.

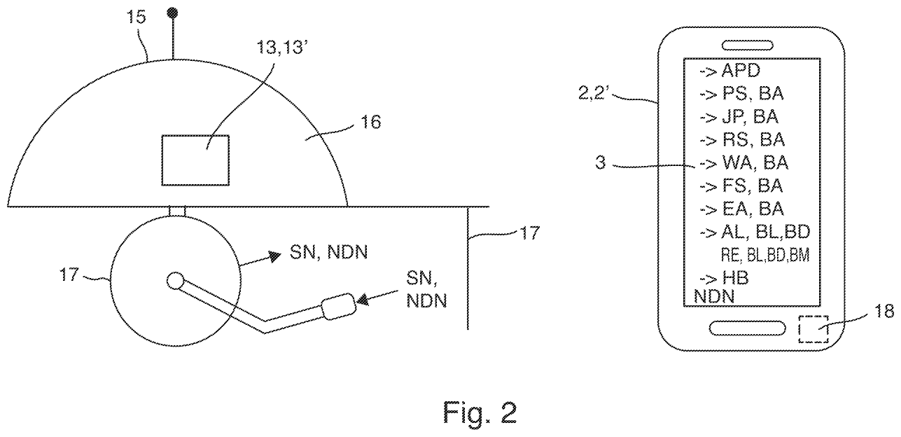

The communication apparatus 2 each have an output and input device 3, as shown in FIG. 2. The output and input device 3 is designed for the output and input of, in particular outputs and/or inputs, work process data APD relevant to one member 5 in a working group 6 about work steps AS on tree sections 4 that are to be worked on and/or have been worked on.

The forest communication system 1 is designed for the reconciling of, in particular transmits and aligns, the work process data APD between the communication apparatus 2 in a peer-to-peer network 7 by means of wireless transmission on the basis of a medium-range transmission technology 8.

The method comprises the step of: reconciling the work process data APD between the communication apparatus 2 in the peer-to-peer network 7 by means of wireless transmission on the basis of the medium-range transmission technology 8, in particular by means of the forest communication system 1.

In detail, the work process data APD are about at least one planting step PS, at least one young stock maintenance step JP, at least one cutting-back step RS, at least one pruning step WA, at least one felling step FS, at least one limbing step EA, at least one cutting-to-length step AL, at least one log-removal step RE, at least one leaning-tree clearance step HB, at least one sequence I, II, III, IV and/or at least one location PO, JO, SO, WO, FO, EO, AO, RO, HO of at least some of the work steps AS and/or of at least some of the tree sections 4.

In particular, the sequence I, II, III, IV of the work steps AS is the felling step FS, then the limbing step EA, then the cutting-to-length step AL and then the log-removal step RE. If the felling step FS results in the tree section 4 getting caught, the leaning-tree clearance step HB is then added, and in particular then the limbing step EA.

Additionally or alternatively, for, or during, the felling step FS and/or the leaning-tree clearance step HB, further work steps AS may or must or should not be performed too close, or within a minimum distance MIDI, in particular of a distance optimization criterion AOK, in particular on account of a danger potential arising from the tree section 4 that is to be felled and/or moved.

Further additionally or alternatively, the leaning-tree clearance step HB is performed by a log-removal vehicle 5′ having a cable winch 5″ with a cable 5′″.

In particular also, the log-removal step RE is interrupted and/or deferred.

In addition, the work process data APD are about at least one tree type BA, at least one tree section length BL, at least one tree section diameter BD, at least one tree section quantity BM, at least one tree section quality BQ and/or at least one tree section value BW.

Additionally, on the basis of triggering by any, in particular new, input IN of, in particular new, work process data nAPD, in particular by means of one of the output and input devices 3, the respective reconciling is performed, in particular afresh.

Further, the reconciling comprises: comparing work process data iAPD that have been input, in particular by means of one of the output and input devices 3, with predefined work process data voAPD that have been output, in particular by means of the output and input device 3. When there is a minimum variance MA, adapting the predefined work process data aAPD about work steps AS on tree sections 4 that are to be worked on on the basis of the minimum variance MA and/or the input work process data iAPD, in particular on the basis of an optimization criterion OK.

In detail, the optimization criterion OK is a danger reduction optimization criterion SOK, a distance optimization criterion AOK and/or a group work progress optimization criterion FOK, a time optimization criterion ZOK and/or a value optimization criterion WOK.

Furthermore, the method comprises the step of: responding to the minimum variance MA, and in particular responding to the adapting on the basis of the danger reduction optimization criterion SOK, by outputting information Info about the minimum variance MA and/or the adapting and/or the adapted work process data aAPD and/or the optimization criterion OK, in particular by means of at least one of the output and input devices 3.

In addition, the method comprises the step of: enabling the adapted work process data aAPD for manual adapting, in particular by means of at least one of the output and input devices 3.

By way of example, at least one of the output and input devices 3 outputs the, in particular predefined, work process data vAPD about the cutting-to-length step AL on the tree section 4 that is to be cut to length to at least one of the members 5 of the working group 6. As a result of the output, the member 5 performs the cutting-to-length step AL, or cuts the tree section 4 to length, in particular successfully. As a result of the performance of the cutting-to-length step AL, or of the cutting-to-length of the tree section 4 that has been cut to length, the member 5 enters the work process data APD about the cutting-to-length step AL on the tree section 4 that has been cut to length by means of the output and input device 3, or confirms the output work process data voAPD. On the basis of triggering by the input IN of the work process data nAPD, the reconciling is performed. The reconciling comprises: comparing the work process data iAPD that have been input with the predefined work process data voAPD that have been output. There is no minimum variance in this case. As a result of the reconciling, at least one, in particular other, of the output and input devices 3 outputs the, in particular predefined, work process data vAPD about the log-removal step RE on the tree section 4 that, in particular, has been cut to length, and is to be removed, to at least one, in particular another, of the members 5 of the working group 6, or enables the log-removal step RE, in particular performance of the log-removal step RE.

Additionally, at least one, in particular once again other, of the output and input devices 3 outputs the, in particular predefined, work process data vAPD about the felling step FS on the tree section 4 to be felled to at least one, in particular once again other, of the members 5 of the working group 6. As a result of the output, the member 5 performs the felling step FS, or fells the tree section 4, in particular unsuccessfully, or the tree section 4 gets caught. As a result of the performance of the felling step FS, or of the felling of the felled tree section 4, the member 5 enters the work process data APD about the felling step FS on the felled tree section 4 by means of the output and input device 3, or the input IN comprises work process data nAPD that differ from the output work process data voAPD. On the basis of triggering by the input IN of the work process data nAPD, the reconciling is performed. The reconciling comprises: comparing the work process data iAPD that have been input with the predefined work process data voAPD that have been output. There is the minimum variance MA in this case. Therefore, the predefined work process data aAPD about the limbing step EA on the tree section 4 that, in particular, has been felled and actually needs to be limbed are adapted on the basis of the minimum variance MA and/or the input work process data iAPD, in particular on the basis of the optimization criterion OK, in particular the danger reduction optimization criterion SOK. In particular, the predefined work process data vAPD about the limbing step EA are not output, or the limbing step EA, in particular the performance of the limbing step EA, is not enabled and/or not output. In particular instead, the minimum variance MA and/or the input work process data iAPD is/are taken as a basis for predefining work process data APD about the leaning-tree clearance step HB on the tree section 4 that, in particular, has been felled, and needs to be moved, in particular on the basis of the optimization criterion OK, in particular the danger reduction optimization criterion SOK and/or the group work progress optimization criterion FOK and/or the time optimization criterion ZOK. As a result of the reconciling, in particular of the minimum variance MA, or the adapting and/or the predefining, at least that, in particular other, one of the output and input devices 3 outputs the, in particular predefined, work process data vAPD about the leaning-tree clearance step HB on the tree section 4 that, in particular, has been felled, and needs to be moved, to at least the, in particular other, one of the members 5 of the working group 6, or enables the leaning-tree clearance step HB, in particular the performance of the leaning-tree clearance step HB, or outputs the information Info about the minimum variance MA and/or the adapting and/or the adapted work process data aAPD and/or the optimization criterion OK. As a result of the output, the member 5 interrupts, or defers, the log-removal step RE. In particular instead, the member 5 performs the leaning-tree clearance step HB, or moves the tree section 4, in particular successfully. As a result of the performance of the leaning-tree clearance step HB, or the moving of the moved tree section 4, the member 5 enters the work process data APD about the leaning-tree clearance step HB on the moved tree section 4 by means of the output and input device 3, or confirms the output work process data voAPD. On the basis of triggering by the input IN of the work process data nAPD, the reconciling is performed. The reconciling comprises: comparing the work process data iAPD that have been input with the predefined work process data voAPD that have been output. There is no minimum variance in this case. As a result of the reconciling, at least one, in particular once again other, of the output and input devices 3 outputs the, in particular predefined, work process data vAPD about the limbing step EA on the tree section 4 that, in particular, has been felled and/or moved, and needs to be limbed, to at least one, in particular once again other, of the members 5 of the working group 6, or enables the limbing step EA, in particular the performance of the limbing step EA.

Additionally, the method comprises the step of: transmitting the, in particular predefined, work process data vAPD from an external database 9 to a gateway 10, in particular a smartphone 11, in the peer-to-peer network 7, in particular wirelessly on the basis of a long-range transmission technology 12.

Further, the forest communication system 1 comprises at least one mobile communication intermediate station 13. In the exemplary embodiment shown, the forest communication system 1 comprises eight communication intermediate stations 13. In alternative exemplary embodiments, the forest communication system may comprise at least two, in particular at least five, in particular at least ten, communication intermediate stations.

Additionally or alternatively, the reconciling is performed between at least one of the communication apparatus 2 and a, in particular the and/or associated, communication intermediate station 13 in the peer-to-peer network 7 by means of wireless transmission on the basis of a short-range transmission technology 14 and by the communication intermediate station 13 by means of the wireless transmission on the basis of the medium-range transmission technology 8.

In alternative exemplary embodiments, the forest communication system does not need to or may not comprise a communication intermediate station. Additionally or alternatively, in alternative exemplary embodiments, the communication device may, in particular itself, or directly, perform the wireless transmission on the basis of the medium-range transmission technology. In other words: in alternative exemplary embodiments, the communication device may, in particular itself, or directly, be designed for wireless transmission on the basis of the medium-range transmission technology.

Furthermore, at least one of the communication apparatus 2 is a body-worn, in particular head-worn, and/or handheld communication device 2′, as shown in FIG. 2. Additionally or alternatively, at least the communication intermediate station 13 is a body-worn, in particular head-worn, and/or handheld communication intermediate station 13′. In particular, the communication device and/or the communication intermediate station 13′ is/are at least arranged, in particular integrated, on an item of forestry worker protective equipment 15, in particular a protective helmet 16 and/or a face and/or hearing protector 17 and/or protective goggles and/or a protective glove.

In the exemplary embodiment shown, at least one of the communication apparatus 2 comprises a smartphone, in particular is a smartphone. Additionally, at least one of the communication intermediate stations 13 comprises a headset, in particular is a headset. In alternative exemplary embodiments, at least one of the communication apparatus may additionally or alternatively comprise, in particular be, a headset.

In addition, the method comprises the step of: wirelessly transmitting a voice message SN, in particular from one of the members 5 and/or between the communication intermediate stations 13, on the basis of the medium-range transmission technology 8 in the peer-to-peer network 7.

Additionally, the method comprises the step of: wirelessly transmitting emergency data and/or messages NDN, in particular from one of the members and/or between the communication intermediate stations 13, on the basis of the medium-range transmission technology 8 in the peer-to-peer network 7 and/or on the basis of the long-range transmission technology 12.

Further, the medium-range transmission technology 8 has a maximum range 8R of 400 m. Additionally or alternatively, the medium-range transmission technology 8 comprises Bluetooth Classic transmission technology BC, in particular is Bluetooth Classic transmission technology BC. Further additionally or alternatively, the medium-range transmission technology 8 uses a 2.4 GHz carrier frequency 8f. Further additionally or alternatively, the long-range transmission technology 12 has a minimum range 12R of 1000 m. Further additionally or alternatively, the long-range transmission technology 12 comprises narrowband Internet of Things transmission technology NB-IoT, Long-Term Evolution transmission technology LTE, long-range transmission technology LoRa and/or SigFox transmission technology SIGFOX, in particular is narrowband Internet of Things transmission technology NB-IoT, Long-Term Evolution transmission technology LTE, long-range transmission technology LoRa and/or SigFox transmission technology SIGFOX. Further additionally or alternatively, the short-range transmission technology 14 has a maximum range 14R of 10 m. Further additionally or alternatively, the short-range transmission technology 14 comprises Bluetooth Low Energy transmission technology BLE and/or ZigBee transmission technology ZB, in particular is Bluetooth Low Energy transmission technology BLE and/or ZigBee transmission technology ZB.

Furthermore, the communication apparatus 2 each comprise a storage medium 18, as shown in FIG. 2. The storage medium 18 is designed for the storage of, in particular stores, the work process data APD.

As the exemplary embodiments shown and explained above demonstrate, the invention provides an advantageous method for operating a forest communication system and an advantageous forest communication system, each of which has improved properties, in particular allows efficient and/or reduced-danger working in the forest.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a forest communication system having multiple mobile communication apparatus, each communication apparatus including an output and input device configured for output and input of work process data relevant to one member in a working group about work steps on tree sections that are to be worked on and/or have been worked on,
the method comprising the steps of:
reconciling the work process data between the communication apparatus in a peer-to-peer network, wherein
the reconciling is based on wireless transmission carried out via a medium-range transmission technology.

2. The method according to claim 1, wherein the work process data are about at least one of:
at least one planting step,
at least one young stock maintenance step,
at least one cutting-back step,
at least one pruning step,
at least one felling step,
at least one limbing step,
at least one cutting-to-length step,
at least one log-removal step,
at least one leaning-tree clearance step,
at least one sequence and/or at least one location of at least some work steps and/or at least some tree sections,
at least one tree type,
at least one tree section length,
at least one tree section diameter,
at least one tree section quantity, or
at least one tree section quality and/or at least one tree section value.

3. The method according to claim 1, wherein,
based on triggering by any new input of new work process data, via one of the output and input devices, performing a respective reconciling afresh.

4. The method according to claim 1, wherein the reconciling comprises:
comparing work process data that have been input with predefined work process data that have been output, and
when there is a minimum variance, adapting the predefined work process data about work steps on tree sections that are to be worked on based on the minimum variance and/or the input work process data, on the basis of an optimization criterion.

5. The method according to claim 4, wherein the optimization criterion is at least one of:
a danger reduction optimization criterion,
a distance optimization criterion and/or a group work progress optimization criterion, or
a time optimization criterion and/or a value optimization criterion.

6. The method according to claim 5, further comprising:
responding to the adapting on the basis of the danger reduction optimization criterion, by outputting information about the minimum variance and/or the adapting and/or the adapted work process data and/or the optimization criterion.

7. The method according to claim 4, further comprising:
responding to the minimum variance, by outputting information about the minimum variance and/or the adapting and/or the adapted work process data.

8. The method according to claim 4, further comprising:
enabling the adapted work process data for manual adapting by way of at least one of the output and input devices.

9. The method according to claim 1, further comprising:
transmitting the predefined, work process data from an external database to a gateway in the peer-to-peer network, wirelessly on the basis of a long-range transmission technology.

10. The method according to claim 1,
wherein the forest communication system has at least one mobile communication intermediate station, and/or
wherein the reconciling is performed between at least one of the communication apparatus and an associated, communication intermediate station in the peer-to-peer network by way of wireless transmission based on a short-range transmission technology and by the communication intermediate station by way of the wireless transmission based on the medium-range transmission technology.

11. The method according to claim 10,
wherein at least one of the communication apparatus is a body-worn and/or handheld communication device, and/or
wherein at least the communication intermediate station is a body-worn and/or handheld communication intermediate station,
wherein the communication device and/or the communication intermediate station is/are at least arranged on an item of forestry worker protective equipment.

12. The method according to claim 11, wherein the forestry worker protective equipment is: a protective helmet, a face and/or hearing protector, protective goggles, and/or a protective glove.

13. The method according to claim 10, further comprising:
wirelessly transmitting a voice message from one of the members and/or between the communication intermediate stations, on the basis of the medium-range transmission technology in the peer-to-peer network.

14. The method according to claim 1, further comprising:
wirelessly transmitting emergency data and/or messages from one of the members, on the basis of the medium-range transmission technology in the peer-to-peer network and/or on the basis of a long-range transmission technology.

15. The method according to claim 9, wherein at least one of:
the medium-range transmission technology has a maximum range of 400 m,
the medium-range transmission technology comprises Bluetooth Classic transmission technology,
the medium-range transmission technology uses a 2.4 GHz carrier frequency,
the long-range transmission technology has a minimum range of 1000 m, or
the long-range transmission technology comprises narrowband Internet of Things transmission technology, Long-Term Evolution transmission technology, long-range transmission technology, and/or SigFox transmission technology.

16. The method according to claim 10, wherein at least one of:
the medium-range transmission technology has a maximum range of 400 m,
the medium-range transmission technology comprises Bluetooth Classic transmission technology,
the medium-range transmission technology uses a 2.4 GHz carrier frequency,
the short-range transmission technology has a maximum range of 10 m, or
the short-range transmission technology comprises Bluetooth Low Energy transmission technology and/or ZigBee transmission technology.

17. The method according to claim 1, wherein
the communication apparatus each comprise a storage medium, the storage medium being designed for storage of the work process data.

18. A forest communication system, comprising:
multiple mobile communication apparatus, each mobile communication apparatus comprising:
an output and input device, the output and input device being configured for output and input of work process data relevant to one member in a working group about work steps on tree sections that are to be worked on and/or have been worked on, and
wherein the forest communication system is configured for reconciling the work process data between the multiple communication apparatus in a peer-to-peer network by way of wireless transmission based on a medium-range transmission technology.
